(19) United States
(12) Patent Application Publication
(10) Pub. No.: US 2021/0137769 A1
(43) Pub. Date: May 13, 2021

(54) Crutch Harness Apparatus

(71) Applicant: Thomas Chi, Seattle, WA (US)

(72) Inventor: Thomas Chi, Seattle, WA (US)

(21) Appl. No.: 17/070,593

(22) Filed: Oct. 14, 2020

Related U.S. Application Data
(60) Provisional application No. 62/924,047, filed on Oct. 21, 2019.

(51) Int. Cl. A61H 3/02

(52) U.S. Cl. CPC A61H 3/02; A61H 2201/1652; A61H 2201/1633

(57) ABSTRACT

An improved ambulatory crutch system is taught, permitting the user's body to be suspended by a seat-based harness apparatus rather than bearing the weight of their body on their hands and axillae. The improved crutch includes a seat-based harness, including a seat assembly, leg loops, and an optional belt. The harness supports the user's body under the ischial tuberosities.

### PROVISIONAL PATENT APPLICATION

This PROVISIONAL PATENT APPLICATION relates generally to improvements to medical crutches to aid in the ambulation of patients with impaired mobility. More specifically, this specification relates to an apparatus for an improved medical ambulatory crutch system.

Crutch ambulation is exceedingly difficult and exhausting for most people. Even in physically fit individuals, all-day use of crutches invariably results in hand and axilla pain.

Many fractures and lower extremity surgeries mandate non-weightbearing or minimal weightbearing status for six weeks or more, and most patients do not tolerate this well. The weight of the crutches is designed to go through the hands, and palm pain is essentially ubiquitous. Most people end up using their axillae (armpits) to share the weight, and this causes pain, chafing, and compression of the brachial plexus nerves, resulting in pain, numbness, or even weakness in the arms. Specialty crutches (forearm crutches, platform crutches) still place weight through the hands or axillae. Elbow platform crutches are imbalanced, heavy, and unwieldy.

In the past, people have tried to improve on crutch technology, without success. For example, U.S. Pat. No. 5,348,035 HARNESS ASSEMBLY FOR A CRUTCH USER to Porter (“PORTER”) attempted to improve crutches with a swinging harness, but this attempt failed to be adopted. Specifically, PORTER's crutch assembly was flawed in that the connecting members from which the harness hung were in the front of the device, causing the user to fall over backwards. Additionally, PORTER appears to be based on a safety harness. The configuration of the straps or ropes in the safety harness causes pressure and pain in where those straps contact the user's body. U.S. Pat. No. 5,348,035 is a standard-issue worker's safety harness with side attachments that does not work adequately and has not been commercially developed.

Accordingly, there remains a need for systems and methods to improve crutches for the benefit of patients.

### DESCRIPTION

Goal of the invention: To alleviate pressure on the hands and axillae when using crutches by transferring weight to a pelvic harness.

A high-strength webbing and seat based harness to create a support under the ischial tuberosities. In one embodiment, the device attaches to crutches. The device mimics the feeling of sitting in a chair or park swing.

This device dramatically reduces weightbearing through the hands and axillae by transferring it to a pelvic support harness.

This device is a harness, similar in concept to a sport climbing harness, but is designed to be used with crutches and is made to be comfortable despite being used continuously all day. A sport harness transfers weight through the legs upwards and forwards to a central loop near the umbilicus; this device transfers weight from the ischial tuberosities to the side of the pelvis and directly upwards to crutches.

One of several unique features of the device is the “seat.” Consider sitting of the edge of a countertop with the legs dangling over the side. The weight goes through the ischial tuberosities (the “sit bones”). The tendency of course is to slide forward and off the countertop. This device mimics the weightbearing but makes it comfortable and prevents the person from sliding off the support.

The sport climbing harness is mostly comfortable, but weight transfer is through the posterior legs and to the front of the body. It cannot be used with crutches, even if crutches are attached to the sides of it.

A worker's safety harness could also be used. This is a device used by construction workers when the danger of falling from a height is high; typically high-rise workers, window washers, or outdoor maintenance workers. This device is extensive, with shoulder suspenders, groin loops, belt support, and multiple attachment points available. It places weight to the loops in the back of the device when falling backwards, front loops when falling forward, and groin when falling downward.

A patent has previously been issued (U.S. Pat. No. 5,348,035) on September 20, L994 for a safety harness-based device. This device is simply a standard-issue safety harness with the crutches attached to the sides. It is NOT comfortable and cannot be worn all day without experiencing pain in the groin. In fact, workers who are required to use these safety harness and must spend any time suspended by them (e.g. window washers) complain that they are extremely uncomfortable if used for any length of time. This crutch attachment version of the worker's harness feels like being suspended by ropes looped just lateral to the genitalia; all the weight cuts through the perineal area. The perineum is not designed to take any weight in humans. If one were being tortured by being “hung by ropes,” this would be the mechanism. One highly experienced commercial worker, when he saw how the instant device worked, recommended that it be placed inside of the mandatory commercial device so workers would actually use them.

The instant invention device places weight not through the perineum, but rather through the “sit bones” or ischial tuberosities. These are where humans are designed to bear weight. A bicycle seat, park swing, or even a standard comfort stool would be analogies. The leg loops are angled laterally rather than superiorly and attach under the anterior superior iliac spine (i.e. below the pelvic brim) rather than high above the belt line such as in U.S. Pat. No. 5,348,035. This creates an approximately 30 degree angled leg loop rather than the 75 degrees of a safety harness, so they become true leg loops rather than groin loops. The seat directs these leg loops laterally and lends support to the shape and structure of the device. It also creates space for the scrotum, which is painfully constricted in U.S. Pat. No. 5,348,035.

The seat is an anatomical structure similar to a comfort bicycle seat but pre-contoured like a child's park swing. It is trapezoidal in shape, with the wide part under the ischial tuberosities and the from part wide enough to direct the anterior leg loops away from the genitalia. Different sizes will be required based on body shape, but similar to a sport climbing harness, there will be a finite number needed as the leg loops will be adjustable; most comfort bicycle seats fit almost all riders. Pictures of the current iteration device are enclosed, but the size will be close to 12×6 inches (width×depth) with a 3 inch anterior and 2.5 inch leg bases.

Other seat embodiments are also part of the instant invention. These include seats made of webbing, cloth, heat molded ABS, wood, and others. An important characteristic is directed weightbearing. It is beneficial that weightbearing is directed to under the ischial tuberosities.

Webbing is used for support. Webbing has been used extensively in safety and climbing harnesses and has proven to be strong and durable. In one embodiment, 2 inch webbing is used that threads through slots in the seat and is padded appropriately. Buckles are used to adjust the leg loop size, join the loops at the side, and attach to the crutches. The buckles allow for significant and easy adjustability. Most of these buckles are widespread and commercially available. The “three-way” attachment of the leg loops and crutch attachment is currently achieved with a commercially available resistance slider buckle, but a specialty buckle could be implemented instead.

Materials used in the construction of the prototype include:
a. ⅛ inch ABS heat molded plastic 2 inch webbing
b. 2 inch side release buckles
c. 2 inch CAM buckles
d. 2 inch tri-glide buckles
e. ¼ inch neoprene padding

In some embodiments, the seat may be constructed from an ABS heat molded plastic frame and a foam such as that used in comfort bicycle seats.

In some embodiments, wherever buckles or connections are used, adjustable connections improve the ability of the user to adjust the device to fit his or her body. Low profile buckles are preferable.

In accordance with the foregoing objectives and others, methods, systems and apparatuses, including improved crutch devices with harnesses, are provided for increasing patient comfort and utility.

In one embodiment, an apparatus is provided. The apparatus is depicted in the enclosed drawings.

In another embodiment, an apparatus is provided and depicted in the enclosed photographs.

Additional details of the invention and additional embodiments are also disclosed in the attached supplemental drawings, figures, presentations, invention disclosure, and other material.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification and the invention. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. An ambulatory crutch apparatus comprising:
a pair of crutches, each crutch having a top portion,
two vertical connecting members,
a seat structure, and
two leg loops, wherein:
each vertical connecting member is attached to the top portion of one of the pair of crutches, and also attached to a lateral portion of the seat structure,
each of the two leg loops are attached to the seat structure,
the seat structure maintains a separation between the leg loops,
the leg loops enclose the leg below the anterior superior iliac spine.
